(19) United States
(12) Patent Application Publication
(10) Pub. No.: US 2003/0074467 A1
(43) Pub. Date: Apr. 17, 2003

(54) Load balancing system and method for data communication network

(76) Inventors: Sasha Peter Oblak, Redwood City, CA (US); David Brian Barcelo, Somerville, MA (US); Alp Mehmetali Guler, New York, NY (US)

Correspondence Address: Raymond A. Nuzzo, Law Offices of Raymond A. Nuzzo, LLC, 579 Thompson Avenue, East Haven, CT, 06512, US

(21) Appl. No.: 09/976,699

(22) Filed: Oct. 11, 2001

(51) Int. Cl. G06F 9/00

(52) U.S. Cl. 709/238; 709/105

(57) ABSTRACT

A load balancing system and method. In one embodiment, the present invention is directed to a method of operating a data communication network having at least one client server and a plurality of recipient servers. The client and recipient servers exchange data packets. Each of the recipient servers has at least one unique service port number and at least one redirect port number. The method generally comprises providing a data packet configured to include a first data segment indicating a destination port number, a second data segment indicating whether the client server is configured to provide port redirection, and a third data segment that enables the recipient servers to acknowledge that the client server is configured to provide port redirection. A load balancer is provided that is configured for effecting transfer of data packets between the client server and recipient servers. The load balancer examines the data segments in the data packets to determine which of the recipient servers shall receive the data packet and whether the data packets are to be redirected.

### BACKGROUND OF THE INVENTION

1. Field of the Invention

The present invention generally relates to a load balancing system and method for effecting data communication in a distributed server network.

2. Description of Related Art

Load balancers are known in the art. Static load balancers are manually tuned by a system operator or system administrator (a human) who observes how work is apportioned among the computers or servers in a system and, based on his or her observations, tunes the system in order to evenly distribute the load. The balancing is fixed when the system is in operation and thus, the system cannot respond to unusual circumstances or changes in the system's usage patterns. If changes are deemed to be necessary, because of failures or slow response times, operator intervention is required and, in the worst case, the system must be shut down while the operator re-tunes it.

Static allocations for jobs and/or transactions have been proposed in the literature. Characteristics of arriving jobs and the computer systems typically constitute static information. If system parameters, e.g., the job/transaction arrival rate, gradually vary with time, such parameters may be estimated and used for improved job/transaction routing. Still, rerouting is triggered by human observation and decision. The policy in this case is termed to be quasi-static or quasi-dynamic, as described by A. Kumar and F. Bonomi in “Adaptive Load Balancing in a Heterogeneous Multiserver System With A Central Job Scheduler”, Proc. of the 8th Int'l Conf. Distributed Computing Systems, June 1988, pp. 500-508.

There are the following varieties of static routing:

1. Probabilistic routing. A fraction of jobs are routed to each computer system according to Bernoulli trials. The probability of being routed to each system is pre-computed to optimize a certain performance measure, such as equalization of processor utilizations at all systems, minimization of the expected overall response time, or equalization of expected response time systems at all systems. The criterion of minimization of the expected overall response time has been considered by J. P. Buzen and P. P. S. Chen, Information Processing 74, pp. 271-175, North Holland, N.Y. (1974), for centralized arrivals, and by A. N. Tantawi and D. Towsley in “Optimal Static Load Balancing in Distributed Computer Systems”, Journal of the ACM, 32(2): 445-465 (1985), for distributed arrivals. The criterion of equalization of expected response time systems at all systems has been considered by L. Georgiadis, C. Nikolaou and A. Thomasian in “A Fair Workload Allocation Policy for Heterogeneous Systems”, IBM T. J. Watson Research Center, RC 14323 (1988).

2. Deterministic routing. In the case of two homogeneous servers, a round-robin routing scheme is optimal, provided that the initial state is identical (e.g., both servers are idle). This is described by A. Ephremides, P. Varaiya and J. Walrand in “A Simple Dynamic routing Problem”, IEEE Transactions on Automatic Control, AC-25(4):690-693, August 1982.

Dynamic load balancers have also been proposed that are fully dynamic; i.e., they reassess the need for load balancing after each transaction. Such systems require such a large amount of overhead that they are not practical. In other words, it takes a lot of processor power to implement dynamic load balancing, processor power that would otherwise be devoted to processing the actual transactions. In the article by S. P. Yu, S. Balsamo and Y. H. Lee entitled “Notes on Dynamic Load Sharing and Transaction Routing”, IBM Research, RC 11537 (1985), a routing decision is made for each message arriving at the distributed system, but these decisions tend to be expensive especially for “short” transactions. P. Krueger and M. Livny in “When Is The Best Load Sharing Algorithm A Load Balancing Algorithm?”, Computer Sciences Dept., University of Wisconsin, Madison, April 1987, study a variety of algorithms combining a local scheduling policy, such as FIFO (first in, first out) or processor sharing, with a global scheduling policy, such as load sharing and load balancing. If the global scheduling policy is to provide work to idling processors, then the policy is one of load sharing, whereas load balancing is performed when the policy is to keep the load of the processors balanced. Several other researchers have proposed dynamic algorithms using the same assumptions. See, for example, M. Livny and M. Melman, “Load Balancing in a Homogeneous Distributed System”, Proceedings of the ACM Computer Networks Performance Symposium, April 1982, D. L. Eager, E. D. Lazowska and J. Zahorjan, “Dynamic Load Sharing in Homogeneous Distributed Systems”, University of Saskatchewan Tech. Report 84-10-01, October 1984, R. M. Bryant and R. A. Finkel, “A Stable Distributed Scheduling Algorithm”, Proc. of the Second International Conf. on Distributed Computing Systems, April 1981, and A. Barak and A. Shiloh, “A Distributed Load-balancing Policy for a Multicomputer”, Software-Practice and Experience, 15(9):901-913, September 1985. Some of these algorithms use process pre-emption when performing process migration. This option is not available to use in on-line transaction processing systems. Whereas it may be sensible to preempt executing on an overloaded processor and migrate it to an under-loaded processor, it is impractical in a transaction environment because of the transaction management overhead.

Conventional load balancing systems are described in U.S. Pat. Nos. 5,283,897, 5,539,883, 5,774,668, 6,023,722, 6,067,545, 6,078,943, 6,128,279 and 6,128,644.

What is needed is a new and improved load balancing system wherein the load balancer (i) is scaleable, (ii) uses relatively less memory space in the load balancing device or switch, and (iii) off-loads the task of maintaining sessions to the distributed servers.

It is an object of the present invention to provide the aforesaid new and improved load balancing system. Other advantages and beneficial features of the present invention will in part be obvious and will in part be apparent from the specification.

### SUMMARY OF THE INVENTION

The present invention is directed to a load balancing system and method for effecting data communication in a distributed server network. The ensuing description in the Summary of the Invention pertains to just a few of the possible embodiments of the invention. Other embodiments and variations of the invention will be in part obvious and will in part be apparent from the Detailed Description of the Preferred Embodiments.

In one embodiment, the present invention is directed to a method of operating a data communication network having at least one client server and a plurality of recipient servers wherein the client servers and recipient servers exchange data packets, each of the recipient servers having at least one unique service port number and at least one redirect port number wherein more than one recipient server shares the same redirect port number, the method comprising the steps of:

providing a data packet configured to include a first data segment indicating a destination port number;

providing a load balancer configured for effecting transfer of data packets between the client server and the recipient servers, the load balancer being configured to examine the first data segment in the data packets to determine which of the recipient servers shall receive the data packet;

determining the destination port number in each first data segment;

determining whether the destination port number in each first data segment matches a service port number of one of the recipient servers or a redirect port number for a subset of the plurality of recipient servers;

forwarding the data packet to a particular recipient server that has a service port number that matches the destination port number in the data packet if the destination port number is determined to be a service port number for that particular recipient server;

selecting a recipient server from the subset of recipient servers that has a redirect port number that matches the destination port number if the destination port number is determined to be a service port number for the set of recipient servers;

forwarding the data packet to the selected recipient server;

configuring a data packet as a reply to the data packet received by the selected server from the client server to include a second data segment that indicates a service port number to which the client server shall direct all subsequent data packets;

thereafter forwarding the configured data packet back to the client server;

reconfiguring the configured data packet received by the client server to indicate a destination port number that matches the service port number defined in the second data segment; and

forwarding the reconfigured data packet to a recipient server that services the service port number defined in the second data segment.

In a related aspect, the present invention is directed to a data communication network comprising:

at least one client server;

a plurality of recipient servers, each of the recipient servers having at least one unique service port number and at least one redirect port number wherein more than one recipient server shares the same redirect port number;

means for providing a data packet configured to include a first data segment indicating a destination port number, a second data segment indicating whether the client server is configured to provide port redirection, and a third data segment that enables the recipient servers to acknowledge that the client server is configured to provide port redirection and to indicate to the client that the recipient server supports port redirection;

a load balancer in data communication with the client server and the recipient servers wherein the load balancer is configured (i) to examine the data segments in the data packet to determine which of the recipient servers shall receive the data packet, (ii) to determine the destination port number in each first data segment, (iii) to determine whether the destination port number in each first data segment matches a service port number of one of the recipient servers or a redirect port number for a subset of the recipient servers, (iv) to forward the data packet to the recipient server that has a service port number that matches the destination port number in the data packet if the destination port number is determined to be a service port number for that particular recipient server, (v) to select a recipient server from a subset of the plurality of recipient servers that have a redirect port number that matches the destination port number if the destination port number is determined to be a service port number for the set of recipient servers and if the second data segment indicates that the client server supports port redirection, and (vi) to forward the data packet to the selected server if the second data segment indicates that the client server supports port redirection;

means for configuring a data packet as a reply to the data packet received by the selected server from the client to indicate that the recipient server acknowledges that the client server supports port redirection and that the recipient server supports port redirection, and to include a forth data segment that indicates a service port number to which the client server shall direct all subsequent data packets;

means for forwarding the configured data packet to the load balancer;

the load balancer being configured to forward the configured data packet back to the client server;

means for reconfiguring the configured data packet received by the client server to indicate a destination port number that matches the service port number defined in the forth data segment; and

means for forwarding the reconfigured data packet to the load balancer;

the load balancer being configured to forward the reconfigured data packet to a recipient server that services the service port number defined in the fourth data segment.

In yet another aspect, the present invention is directed to a load balancer for effecting data communication between at least one client server and a plurality of recipient servers wherein each of the recipient servers has at least one unique service port number and at least one redirect port number wherein more than one recipient server shares the same redirect port number, the load balancer comprising:

means for receiving data packets configured to include a first data segment indicating a destination port number, a second data segment indicating whether the client server is configured to provide port redirection, and a third data segment that enables the recipient servers to acknowledge that the client server is configured to provide port redirection;

means for examining the data segments in the data packet to the destination port number in each first data segment;

means for determining whether the destination port number in each first data segment matches a service port number of one of said recipient servers or a redirect port number for a subset of the plurality of recipient servers;

means for forwarding the data packet to the recipient server that has a service port number that matches the destination port number in the data packet if the destination port number is determined to be a service port number for that particular recipient server;

means for selecting a recipient server from a subset of the plurality of recipient servers that has a redirect port number that matches the destination port number if the destination port number is determined to be a service port number for the subset of recipient servers and if the second data segment indicates that the client server supports port redirection;

means for forwarding the data packet to the selected server if the second data segment indicates that the client server supports port redirection;

means for processing data packets responsively sent by the selected server to determine if the recipient server acknowledges that the client server supports port redirection and that the recipient server supports port redirection, and to determine if the data packets sent by the selected server includes a forth data segment that indicates a service port number to which the client server shall direct all subsequent data packets;

means for forwarding the processed data packets to the client server;

means for processing data packets responsively sent by the client server to determine if the data packet includes a destination port number that matches the service port number defined in the forth data segment; and

means for forwarding the data packet received from the client server to a recipient server that services the service port number defined in the fourth data segment.

In a related aspect, the present invention is directed to a data packet configured for use in a data communication network having at least one client server and a plurality of recipient servers. The data packet comprises a first data segment indicating a destination port number, a second data segment indicating whether the client server is configured to provide port redirection, and a third data segment that enables the recipient servers to acknowledge that the client server is configured to provide port redirection. In one embodiment, the data packet further comprises a fourth data segment that indicates a service port number to which the client server shall redirect subsequent data packets.

### BRIEF DESCRIPTION OF THE DRAWINGS

The figures are for illustration purposes only and are not drawn to scale. The invention itself, however, both as to organization and method of operation, may best be understood by reference to the detailed description which follows taken in conjunction with the accompanying drawings in which:

FIG. 1A is a diagram illustrating the OSI networking model with which the load balancing system and method of the present invention are implemented.

FIG. 1B is a diagram illustrating a network data segment.

FIG. 2 is block diagram of a data communication network utilizing the load balancer of the present invention.

FIG. 3 is a block diagram illustrating data communication between a client computer or server and a recipient server.

FIG. 4 is a block diagram, similar to FIG. 2, of a data communication network utilizing the load balancer of the present invention.

FIG. 5 is a block diagram illustrating a data communication network configured as a tree type network which utilizes a plurality of load balancers of the present invention.

### DETAILED DESCRIPTION OF THE PREFERRED EMBODIMENTS

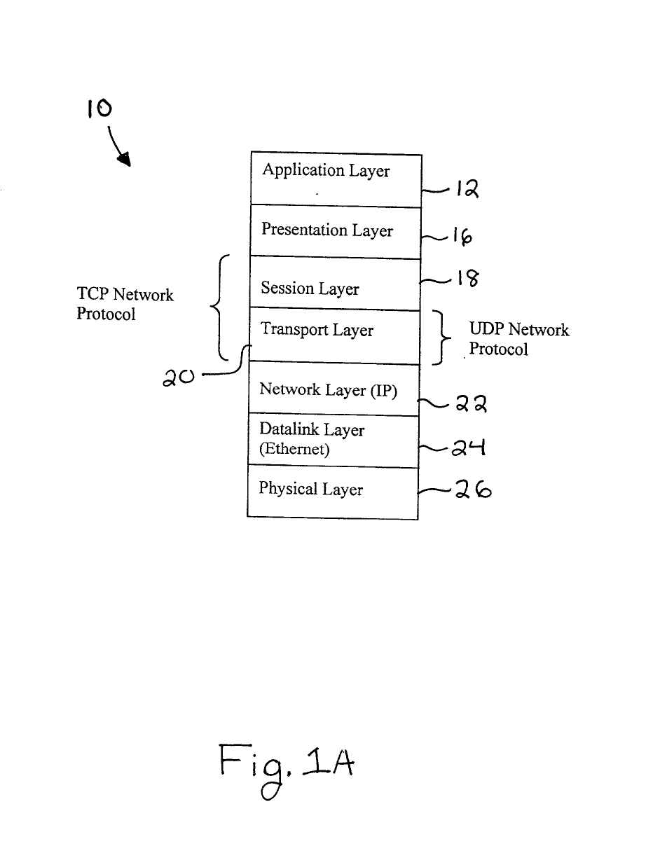

In describing the preferred embodiments of the present invention, reference will be made herein to FIGS. 1-5 of the drawings in which like numerals refer to like features of the invention.

Referring to FIG. 1, there is shown a diagram of the OSI (“open systems interconnection”) networking model or framework 10 which is well known in the art. Networking model 10 comprises application layer 12, presentation layer 14, session layer 16, transport layer 18, network layer (IP) 20, data-link layer (Ethernet) 22, and physical layer 24.

Referring to FIG. 1A, there is shown a diagram that illustrates the configuration of a typical network data packet. Packet 30 includes data segment 32, TCP (or UDP) header segment 34, IP header segment 36, and Ethernet header segment 38.

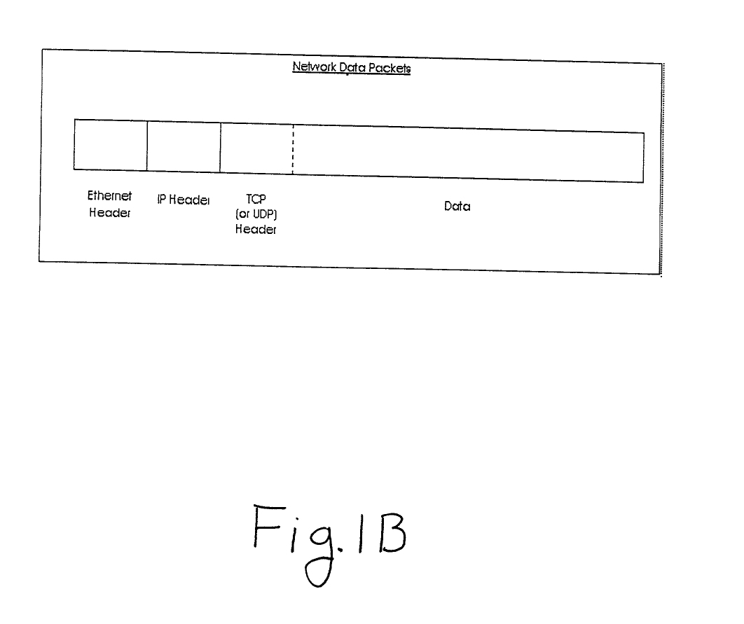

Referring to FIG. 2, there is shown a data communication network that operates in accordance with one embodiment of the present invention. Data communication network 100 generally comprises client server 102 and load balancer 104 which are in data communication with network 106. In one embodiment, load balancer (or load balancing switch) 104 comprises the appropriate electronic processing circuitry such as central processing units, read-only-memory, random-access-memory, cache memory and data interface circuitry. Network 106 can be realized by such communication networks such as the Internet. Network 100 further includes a plurality of recipient servers 108a-d which are in data communication with network 106.

In order to facilitate understanding of the present invention, the ensuing description is divided into separate discussions relating to implementation of the load balancer system and method of the present invention with relatively simple and complex protocols.

1. Simple Protocols

The load balancer system and method of the present invention may be used with relatively simple protocols. One example of such a protocol is the User Datagram Protocol (“UDP”), which is known in the art and is typically used on transport layer 18 of the OSI networking model 10. In order to facilitate understanding of the present invention, and for purposes of example, the ensuing description is in terms of the UDP. However, it is to be understood that the present invention can be used with other simple protocols. UDP achieves the desired efficient data communication and data transactions for relatively simple data communication networks. UDP is defined to make available a datagram mode of packet-switched computer communication in the environment of an interconnected set of computer networks.

The first step of this embodiment of the method of the present invention is to assign service port numbers and redirect port numbers to the servers 108a-d. Unique service port numbers are assigned to a particular recipient server, while redirect port numbers are assigned to a group of servers. The group of servers may be any valid subset of servers attached to the load balancer 104. For a simple protocol, like UDP, a service port is a redirect port having a corresponding set of servers that contains just one server. The assignment of redirect and service port numbers is typically done by the system administrator. This step also includes entering the assigned service and redirect port numbers into load balancer 104. Thus, load balancer 104 is programmed to recognize the assigned service and redirect port numbers of recipient servers 108a-d. Referring to FIG. 2, service port numbers 1, 5 and 9, and redirect port numbers 20 and 22 are assigned to server 108a. Service port numbers 2, 6 and 10, and redirect port numbers 20, 21 and 22 are assigned to server 108b. Service port numbers 3, 7 and 11, and redirect port numbers 21 and 22 are assigned to server 108c. Service port numbers 4, 8 and 12, and redirect port numbers 21 and 22 are assigned to server 108d. These service and redirect port numbers are used for purposes of example.

Next, client server or computer 102 sends a data packet to load balancer 104 for routing to an appropriate one of recipient servers 108a-e. The header of the data packet contains a destination port number, and may also contain a source port number. The source port number indicates which program of the client server 102 sent the data packet. Load balancer 104 examines the data packet to determine the protocol. Assuming that the protocol is a relatively simple protocol, like UDP, the load balancer 104 then determines the destination port number within the header of the data packet. Next, load balancer 104 selects one of servers 108a-e to which the data packet shall be sent. The load balancer determines whether the destination port number matches any of the pre-stored service port numbers or redirect port numbers that are assigned to the recipient servers 108a-d. If load balancer 104 determines that the destination port number is actually one of the pre-stored service port numbers, then load balancer 104 sends the data packet to the particular server (i.e. one of servers 108a-e) that has the service port number that matches or corresponds to the destination port number in the header of the data packet. If load balancer 104 determines that the destination port number does not match or correspond to any of the pre-stored service port numbers, load balancer 104 then determines whether the destination port number matches or corresponds to any of the redirect port numbers. If the destination port number does match or correspond to any of the redirect port numbers, then the load balancer 104 selects one of servers 108a-e that will receive the data packet. For example, if the destination port number is 22, the load balancer 104 determines that the destination port number does not match or correspond to any of the service port numbers but does match or correspond to one of the redirect port numbers assigned to the group of servers 108a-e, then load balancer 104 selects one of servers 108a-e to which the data packet shall be sent. Load balancer 104 is configured to implement one or more of known algorithms for selecting one of servers 108a-e that shall receive the data packet. Such algorithms include random, round robin, and elevator algorithms. Load balancer 104 also can be configured with statistical algorithms that are based on such factors as the amount of load carried by each server 108a-e, the number of data packets load balancer 104 is sending to each of the recipient servers, and the data within the data packet.

All packets which the servers send to the load balancer and which are destined for a client server on the network are passed onto the network by the load balancer. The network continues to forward that packet as it would any other packet. The load balancer may examine the packet and/or change any fields within the packet as the load balancer passes the packet to the servers.

In the configuration of the invention described in the foregoing description, load balancer 104 is stateless and client server 102 operates as though load balancer 104 and servers 108a-e function as a single server. Thus, client server 102 outputs data packets as if load balancer 104 and the distributed recipient servers 108a-e are a single server. Data packets sent from one server to the other server are completely independent of each other. The header information within a simple protocol like UDP basically contains only the port numbers of the host (or client) server and the destination recipient server. The headers of these data packets do not need any flags or options. One feature of using such simple protocols such as UDP is that segments of data are sent almost blindly over the network whereby the recipient server does not send an acknowledgement, and the host or client server does not require an acknowledgement.

2. Complex Protocol

The ensuing description pertains to the load balancing system and method of the present invention implemented with relatively complex protocols such as the Transmission Control Protocol (“TCP”) which is well known in the art. For purposes of example, and to facilitate understanding of the invention, the ensuing description is in terms of the load balancing system and method of the present invention being configured to utilize TCP. TCP is configured for use as a highly-reliable host-to-host protocol between hosts in packet-switched computer communication networks, and in interconnected systems of such networks. TCP interfaces on one side to user or application processes and on the other side to a lower level protocol such as Internet Protocol (“IP”). Specifically, TCP fits into a layered protocol architecture just above the basic IP protocol which provides a way for TCP to send and receive variable-length segments of information enclosed in internet data-gram “envelopes”. The internet data-gram provides a means for addressing source and destination computers, servers, or nodes in different networks. IP also deals with any fragmentation and re-assembly of TCP segments required to achieve transport and delivery through multiple networks and interconnecting gateways. IP also carries information on the precedence, security classification and compartmentation of TCP segments, so this information can be communicated end-to-end across multiple networks. An important feature of TCP is that it is able to transfer a continuous stream of octets in each direction between its users by packaging some number of octets into segments for transmission through a networking system, like the Internet. TCP decides when to block and forward data at its own convenience. TCP allows for several applications on a host to have several communication sessions with a single server or several servers.

In one embodiment, the load-balancer is configured to support fragmentation. In another embodiment, the load-balancer is not configured to support fragmentation. If the load-balancer is configured to support fragmentation, the load balancer recognizes the fragmented packets and maintains a cache of important information, like the fragment identifications and the source and destination IP numbers of data packets that pass there through. When the load balancer receives a packet having a fragment identification and a source and destination IP number that is recognized by the load balancer, the load-balancer forwards the packet to the appropriate server. If the load-balancer receives a packet with an identification and source and destination IP numbers that it does not recognize, the load balancer can either forward the packet to the default server, or drop the packet.

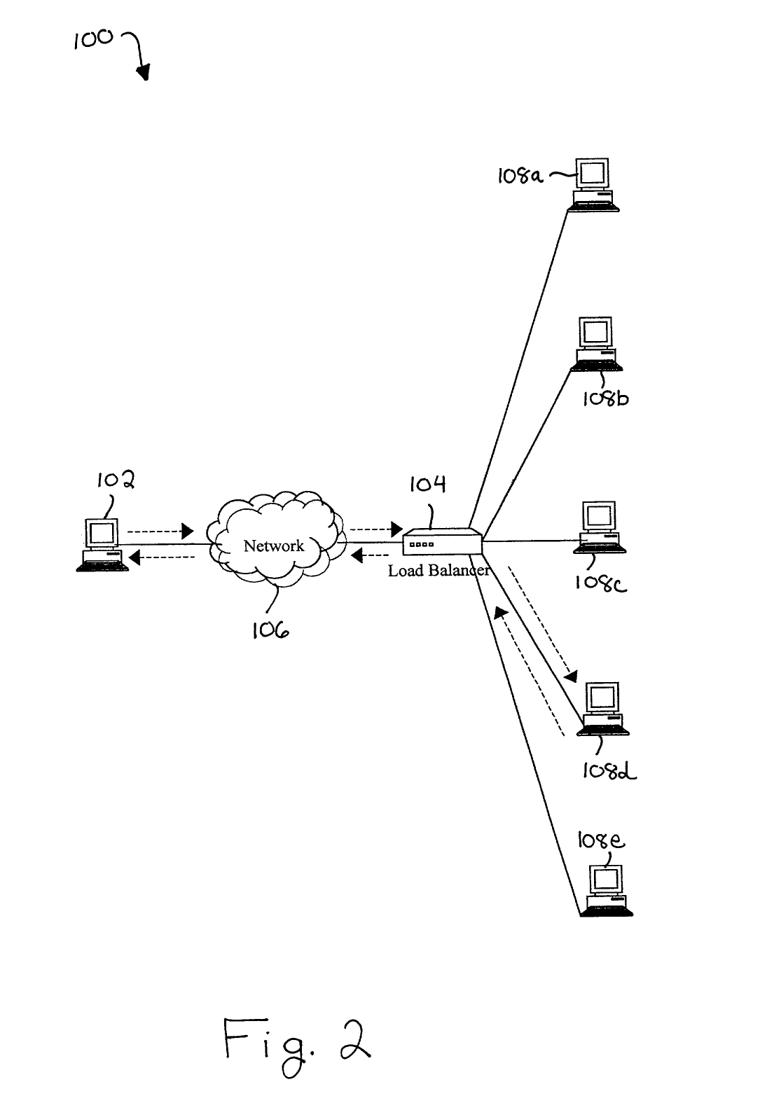

For purpose of discussing this embodiment of the invention, reference is made to FIGS. 3A and 3B.

A complex protocol such as TCP has three major states: (i) establishing a connection, (ii) send data over the connection, and (iii) close the connection. Each one of these states is described in the ensuing description.

a) Establishing a Connection

For purposes of discussion and to facilitate understanding of the invention, FIG. 3A provides a simplified diagram that illustrates how a connection is established in complex protocol such as TCP. Client computer or server 200 is in data communication with network 202 and is attempting to establish a data communication connection with recipient computer or server 204. In order to open or establish a data communication connection with computer 204, computer 200 sends computer 204 a packet having a Synchronization (“SYN”) Bit that is set. In response, computer 204 sends a reply packet with the SYN Bit set and an Acknowledgement (“ACK”) bit set. Next, computer 200 sends a reply packet with the ACK bit set to computer 204. All messages being sent to computer 204 have a destination port “X” and all messages being sent from computer 204 to computer 200 will have a source port equal to “X”.

In accordance with the invention, the data packet is configured to include several new flags (or bits) and options in order to enable this protocol to be used in distributed networks such as the one shown in FIGS. 2 and 3B. Specifically, the header of the data packets exchanged by the client server and recipient server are configured to include:

i) REDIRECT flag: a flag that indicates the client or host server supports port redirect functions. The REDIRECT flag allows the load-balancer to inform the respective distributed server that the client server supports port redirection. The REDIRECT flag can be implemented by any means which indicates the client server supports being redirected. For example, the REDIRECT flag can be realized by a combination of bits, a special option, a combination of options and/or bits, or anything else that informs the load-balancer and the respective recipient server that the client server supports being redirected;

ii) REDIRECT_CONFIRM flag: a flag that indicates the recipient server acknowledges that the client or host server supports redirect functions, and indicates to the client that the recipient server supports port redirection. As with the REDIRECT flag, the function of the REDIRECT_CONFIRM flag can be implemented by any means which indicates the recipient server acknowledges that the client server supports port redirection. For example, the REDIRECT_CONFIRM flag can be realized by a combination of bits, a special option, a combination of options and/or bits, or anything else that informs the load-balancer and the client server that the recipient server acknowledges that the client server supports being redirected. The implementation of the REDIRECT_CONFIRM flag can be the same flag as the REDIRECT flag since these flags are used at different times;

iii) REDIRECT_OPT: an option in a data packet transmitted by (1) a client or host server that defines a source port number from which a data packet is redirected back to the client or host server, or (2) a recipient server that defines a source port number to which a data packet should be redirected.

When the recipient server decides to redirect the client server, the recipient server may set the REDIRECT flag or the REDIRECT_CONFIRM flag depending upon the implementation.

The recipient server may or may not have the REDIRECT flag set when the recipient server sends its packets to the client server. If the recipient server sets the REDIRECT flag in order to indicate to the client server that the recipient server wants to initiate redirection, the recipient server also sets the REDIRECT_OPT to the port to which redirection should be made. In one embodiment, the recipient server also sets the REDIRECT_CONFIRM flag. However, in another embodiment, the recipient server does not set the REDIRECT_CONFIRM flag when the recipient server provides a new port number within the REDIRECT_OPT.

In one embodiment, the REDIRECT flag is only set by the client:

a) when the client server is initiating the connection;

b) when the client server wants to redirect the recipient server; and

c) after the recipient server redirects the client server during a connection, wherein the client server sets the REDIRECT flag on the next packet.

In one embodiment, the recipient server sets the REDIRECT flag:

a) when the recipient server is replying to the client server's initial connection request whether or not the recipient server is redirecting the client server (setting the REDIRECT flag can also function as a REDIRECT_CONFIRM flag which informs the client server that the recipient server supports redirection);

b) when the recipient server wants to redirect the client server; and

c) after the client server redirects the recipient server during a connection, the client server may set the REDIRECT flag on the next packet.

In an alternate embodiment, when the client server is confirming that it has been successfully redirected, the REDIRECT_OPT flag in the packet sent by the client server to the recipient server does not include the port from which the client server was redirected.

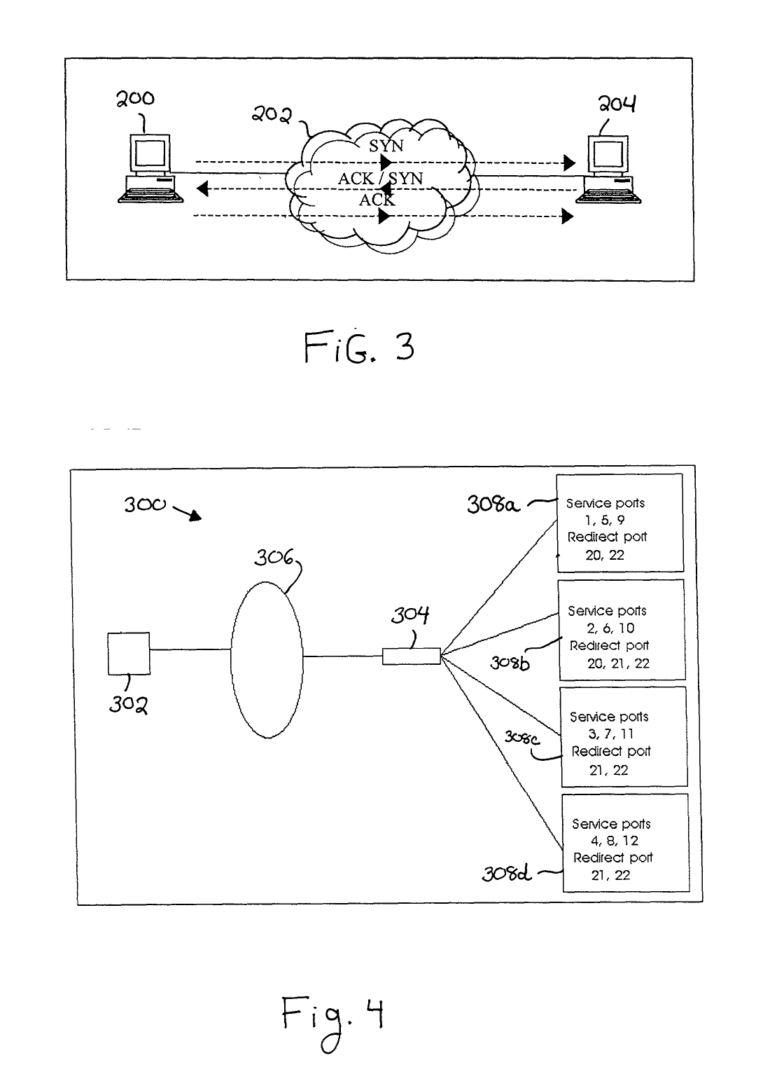

Referring to FIG. 4, there is shown distributed network 300 that includes client or host server 302 and load balancer 304 which are in data communication with network 306. A plurality of recipient computers or servers 308a-d are in data communication with load balancer 304.

In one embodiment, load balancer 304 does not contain any information or data that indicates the existence or quantity of recipient servers. In such an embodiment, load balancer 304 just outputs data packets through the external connectors (not shown) of load balancer 304.

Load-balancer 304 forwards data packets to the appropriate distributed recipient servers 308a-d. Specifically, load-balancer 304 processes the header segment of the data packets to determine the recipient servers to which the data packets shall be sent. In a further embodiment of the invention, load balancer 304 is configured to implement QOS (quality of server) processing on the packets. In another embodiment, load-balancer 304 is configured so as to enable a system administrator to directly log into or connect to the load balancer in the same manner as the system administrator directly logs or connects to a server.

For purposes of describing the present invention, client server 302 and one of recipient servers 308a-d are considered to be communicating just after the point in time when one of the distributed servers receives the first packet from the client server 302 (a SYN packet) Thus, a recipient server (e.g. 308a-d) can redirect at any point in time after it receives a SYN packet from client server 302.

Client or host server 302 does not have a concept of the load-balancer 304 and distributed recipient servers 308a-d. Client server 302 operates as though the load-balancer 304 and the distributed recipient servers 308a-d constitute a single server. Client server 302 has no information about the quantity of distributed recipient servers. Furthermore, client server 302 does not require any information as to the other components in network 300. Client server 302 just sends data packets as though the load-balancer 304 and the distributed recipient servers 308a-d constitute a single server.

Thus, the client server does not know whether the recipient server or servers and load balancer constitutes a distributed server or not. Therefore, the client server sends the packets as in the manner described in the foregoing description. Although a recipient server (or distributed server) responds to the client server, the recipient server may or may not redirect the port number. The server or distributed servers may be configured to set the REDIRECT_CONFIRM flag to inform the client server that it supports a redirect function even though the recipient server does not actually redirect the client at that time. Thus, this protocol is suitable when only a single server is used. However, if the load is to be distributed amongst a plurality of servers, the load balancer of the present invention is utilized.

All data packets sent by client server 302 to distributed servers 308a-d pass through the load-balancer 304, and what the load-balancer 304 does with the packets depends on the data within the packet which defines the destination port and REDIRECT flag. The load-balancer does not maintain any state.

In accordance with the invention, the first data packet transmitted by the client server 302 now includes a set SYN bit, a set REDIRECT flag, and a destination port (e.g. “X” ). If “X” represents a service port number, e.g. service port number 9, and there is a server (e.g. server 308a) that specifically services port 9, then load balancer 304 automatically sends that data packet to recipient server 308a. Server 308a replies to client server 302 with a reply packet containing the SYN bit set, the ACK bit set and the source port equal to “X”. The reply packet transmitted by server 308a further includes a set REDIRECT_CONFIRM flag that indicates recipient server 308a acknowledges that client server 302 is configured to support a packet redirection function, and the flag indicates to the client server 302 that the recipient server supports port redirection. Since the destination port in the data packet transmitted by client server 302 is a port that is serviced by recipient server 308a, the recipient server 308a is not going to redirect the data packet, so it is not necessary for the recipient server to set the REDIRECT_CONFIRM flag or a REDIRECT_OPT flag. However, in a preferred embodiment, the recipient server 308a still sets the REDIRECT_CONFIRM flag to indicate to the client server 302 that recipient server 308a supports port redirection. Once client server 302 receives the data packet from server 308a, client server 302 replies to recipient server 308a with a data packet having the ACK bit set and the destination port equal to 9 thereby establishing the data communication connection.

Referring to FIG. 4, if the destination port number “X” does not correspond to a service port number serviced by any of recipient servers 308a-d but instead, represents a redirect port, then load balancer 304 selects a recipient server that will receive the packet. For example, if the redirect port number is “21”, then load balancer 304 must select one of servers 308a-d since all of these recipient servers are assigned redirect port number “21”. Load balancer 304 may use any of the well known algorithms and techniques for selecting a server from the group consisting of servers 308a-d. After load balancer 304 selects the recipient server, the load balancer 304 sends the packet to the selected recipient server. The selected recipient server replies to client server 302 with a packet having the REDIRECT_CONFIRM flag set, the SYN bit set, the ACK bit flag, and the source port equal to “X”. The data packet transmitted by the selected recipient server further includes a REDIRECT_OPT flag. The REDIRECT_OPT flag is set to a particular value “Y” that indicates an actual service port number that is serviced by that selected recipient server. Thus, the value “Y” informs client server 302 of the new service port number to which the data packet must be sent. For example, if the selected recipient server is server 308a which has a service port number of “5”, then server 308a sends a packet to client server 302 that includes a REDIRECT_OPT flag set to “Y=5”. In response, client server 302 replies to the selected recipient server 308a with a data packet that includes the ACK bit set, the REDIRECT_CONFIRM flag set, the destination port equal to “Y=5” (i.e. the service port of selected server 308a) and a REDIRECT_OPT flag set to “X”. The data communication connection is now established as a result of the previous exchange of transmissions between the client server 302 and the selected recipient server 308a. Client server 302 proceeds to transmit all subsequent data packets to the selected server 308a.

In the event that client server 302 does not support port redirection, the REDIRECT flag is not set when client server 302 sends the packet to load balancer 304. Load balancer 304 analyzes the packet and is now aware that client server 302 does not support port redirection. Therefore, the load balancer can no longer consider the destination port in the packet, e.g. “X”, as a redirect port number. The load balancer must consider it a service port number. If there is a recipient server (e.g. one of the recipient servers 308a-d) assigned “X” as service port number, the load balancer 304 will forward the packet to such recipient server. If there is no recipient server having “X” assigned thereto as a service port number, the load balancer may simply drop the packet (or not forward the packet to any server). As a result of this process, every redirect port number may also be a service port number for one of the recipient servers. Load balancer 304 automatically forwards packets to the server (e.g. one of servers 308a-d) that services the service port number in question. Since the REDIRECT flag in the packet is not set, the recipient server automatically determines that client server 302 does not support port redirect processing. Therefore, the recipient server replies to client server 302 by sending a packet having the SYN bit set, the ACK bit set and the source port equal to “X”, which now represents a service port number. Client server 302 responds to the recipient server with a data packet having the ACK bit set and the destination port equal to “X”. Since the REDIRECT flag is not set again, the load balancer passes this packet to the same recipient server.

In an alternate embodiment, the client server does not set the SYN flag when the client server is being redirected. Since the load balancer is aware that the REDIRECT flag is set, or that the REDIRECT_OPT has been set.

In another embodiment, network 300 includes a default server to which load balancer 304 sends all packets with unknown destination port numbers.

In another embodiment, if the load balancer has difficulty in determining the information from a packet or where a packet should be sent, or if the load balancer does not support the packet or its protocol, the load balancer either drops the packet of forwards the packet to the default server.

In another embodiment, if no default server exists, the load-balancer 304 drops the packet.

In a further embodiment, one of the recipient servers is designated as a default recipient server if it is determined that the header data indicates the client server does not support port redirection, and the data packet is forwarded to the default recipient server if the header information defines a destination port number that does not match any of the service or redirect port numbers of the recipient servers.

In another embodiment, one of the recipient servers is designated as a default recipient server if it is determined that the header information indicates that the client server does not support port redirection, and the data packets are forwarded to the designated default server.

In another embodiment, if there does not exist a default server or any server for a specific port number, the packet is dropped.

If the load balancer receives a packet that does not fit any criteria, it will forward the packet to a default server if one exists, or else it will drop the packet.

It is to be understood that the load balancer of the present invention is configured to examine all areas of packet since different protocols may have destination port numbers in different areas of the packet. Some protocols actually have the destination port number in the data portion or data segment of the data packet, as is the case with ICMP. ICMP is a significant element of IP and TCP/IP.

b) Transmission of Data Over the Connection

After a connection is established, the client server 302 and the one of recipient servers 308a-d exchange messages (i.e. data packets) as defined by the original protocol. Thus, if the original protocol is TCP, then the transmission of data will follow TCP methodology. When the recipient server sends messages to client server 302, the messages contain source port addresses equal to a value “Y”. Client server 302 responds with the ACK bit set and a destination port number equal to the value “Y”. When the client server 302 sends messages to the recipient server, the messages contain destination port addresses equal to a value “Y”. The recipient server 302 responds with the ACK bit set and a source port number equal to the value “Y”. If a recipient server needs to direct client server 302 to redirect messages to a destination port “Z”, recipient server sends a message to client server 302 with the source port number equal to “Y”, the REDIRECT flag set, and the REDIRECT_OPT set to a value of “Z”. The client server 302 closes its old connection by sending a closing connection packet to the original recipient server with a destination port number set to “Y”. Client server 302 replies to the recipient server with the SYN bit set, the REDIRECT flag set, the destination port set to “Z”, and the REDIRECT_OPT set to “Y”. Thus, client server 302 is now opening a connection on port “Z”. For example, if recipient server 308c is currently receiving messages from client server 302 through service port “7” and needs to direct client server 302 to redirect messages to destination port “11”, recipient server 308c sends a message to client server 302 with the REDIRECT flag set and the REDIRECT_OPT set to a value of “11”. Client server 302 replies to the recipient server 308c with the SYN bit set, the REDIRECT flag set, the destination port set to “11”, and the REDIRECT_OPT set to “7”. Thus, client server 302 is now opening a connection on port “11”. Since “11” is a service port serviced only by recipient server 308c, load balancer 304 forwards the packet to recipient server 308c. Recipient server 308c replies to the client server 302c with the SYN bit set, the ACK bit set, the source port set to “11”, and the REDIRECT_CONFIRM flag set. Since the recipient server 308c is configured to service packets with the destination port number 11, the recipient server 308c server does not redirect the message again. Instead, the recipient server 308c server services the messages. Client server 302 replies with the ACK bit set and the destination port set to “11”.

If “Z” is a redirect port number, e.g. “21”, load balancer 304 then selects a recipient server (e.g. one of servers 308a-d) to which the message is sent. Load balancer 304 can use one of any number algorithms and techniques known in the art for effecting selection of one of the servers. Once load balancer 304 makes a selection, the selected recipient server replies to client server 302 with the SYN bit set, the ACK bit set, the source port address set to “Z”, the REDIRECT_CONFIRM bit set, and the REDIRECT_OPT set to a value “W”. The value “W” represents the port to which messages shall be sent. In response, client server 302 replies with the ACK bit set, the REDIRECT_CONFIRM flag set, the destination port set to “W”, and the REDIRECT_OPT with a value of “Z”. Thus, the client server 302 has now opened a connection on port “W”. The selected recipient server may actually be the same server as before, however the connection established is with a different port (i.e. port “W” instead of port “Z”).

In one embodiment, if the client server 302 does not close the connection with the original recipient server by sending a packet with a destination port number “Y” and the REDIRECT_CONFIRM flag set, the recipient server will time out, basically assuming either the client server 302 received the message sent by the recipient server or the communication link broke down.

In an alternate embodiment, instead of closing the connection with the original recipient server and opening a new connection with a new recipient server, the client server resets the connection as defined by TCP/IP in conjunction with the REDIRECT, REDIRECT_CONFIRM, and REDIRECT_OPT flags.

The recipient servers may be configured to record receipt of a packet regardless if the packet is to be redirected. This information will enable the recipient servers to effect redirection at a later time if necessary.

c) Closing A Connection

Closing a connection proceeds in the normal method as described in the original protocol. If the original protocol is TCP/IP, the connection will be closed as defined by TCP/IP. In one embodiment, no memory is allocated within the load-balancer and so the load balancer will not require information concerning when the connection is closed.

In an alternate embodiment, the load balancer is configured to include memory capability that will enable the load balancer to examine the time when the connection is closed.

In accordance with the invention, load balancer of the present invention operates in the manner described in the foregoing description even if there are no recipient servers connected to the load balancer. In other words, the load balancer does not really know if there any recipient servers connected thereto, or if there are servers, the actual quantity.

The load balancer includes external connectors (not shown) that are part of the load balancer's data interface circuitry. The load balancer has one set of external connectors for effecting data communication with the network and/or client servers, and another set of external connectors for effecting data communication with the recipient servers. The load balancer associates port numbers with the different external connectors. The external connectors used with the distributed servers (i.e. recipient servers) have different “port numbers” assigned thereto for which the recipient servers are responsible. These “port numbers” are the port numbers referred to as redirect and service port numbers which have been described in the foregoing description.

Thus, when the load-balancer receives a packet from the network side and that packet includes a service port number as a destination port number, the load balancer sends the packet out on the external connector which has assigned thereto that particular port number. If the load balancer receives a packet from the network side and that packet has a destination port number that is a redirect port number, the load-balancer chooses the external connector to which the packet shall be sent.

The external connectors described in the foregoing description can be physical or virtual external connectors.

d) Other Features

It is to be understood that the data communication methodology of the present invention, as described in the foregoing description, can be done on any level of the OSI networking protocol. Furthermore, although the foregoing description is in terms of “port numbers” being used to address computers or servers, it is to be understood that the present invention can be used with any other type of data that can address a computer, server, computer program or application.

The “port redirection” protocol of the present invention, as described in the foregoing description, can be implemented on any level of the OSI networking protocol. Computers/servers on a network have different addresses at different levels that uniquely address some aspect of the server or protocol. These addresses can be used instead of the port numbers in conjunction with this redirection protocol. On the Session Layer and Transport Layer (TCP and UDP), there exists destination and source port numbers that “address” or signify the application for which a packet is destined. On the Network Layer (IP), there is a destination and source network address (IP address) that uniquely addresses a server/network on the entire network so the network address (IP address) is used as the port numbers. On the data link layer (Ethernet layer), there is a source and destination hardware address (Ethernet address) that is used to address a computer's/server's datalink connector so the Datalink address (MAC address) will be used as the port numbers. In other words, every computer/server has a data link interface (Ethernet card, modem, etc) that has a specific address and allows the server/computer to send data on a physical medium (Ethernet, phone lines, etc.). Thus, the redirection protocol of the present invention can be used on any layer of the OSI networking model 10.

Although the redirection protocol is described in the foregoing description as using port numbers to address the distributed servers, it is to be understood that the redirection protocol can be implemented by using an extra field within the any of the protocols on any layer of the OSI networking model 10. In such a configuration, all that would be needed is a field in the packet's header that specifies the distributed server to which the packet is to be sent.

It is to be understood that TCP is one example of a protocol with which the load balancer of the present invention can be used. The load balancer may be used with other protocols. The use of other protocols may necessitate the use of bits that are comparable to and perform the same function as the SYN, FYN and ACK bits described in the foregoing description. Similarly, the use of other protocols may necessitate the use of flags that are comparable to and perform the same function as the REDIRECT flag, REDIRECT_CONFIRM flag and REDIRECT_OPT which were described in the foregoing description. Thus, it is to be understood that the REDIRECT flag, REDIRECT_CONFIRM flag and REDIRECT_OPT are suitable for use with a pre-existing protocol such as TCP but may not be used with other protocols. Other protocols may necessitate the use of other types of indicating data that achieves the same purpose or function of the REDIRECT flag, REDIRECT_CONFIRM flag and REDIRECT_OPT.

The load-balancer of the present invention is configured to attempt to determine the port number for any type of protocol. However, in some protocols, the port number is relatively deeper in the data packet or more difficult to find than in other protocols. Furthermore, in some protocols, such as the Internet Control Message Protocol (ICMP), typically there are no port numbers in the headers of the ICMP. The ICMP is a protocol that works on top of IP headers on top of Ethernet headers. ICMP provides particular information to the server or computer that sends a data packet. Such particular information includes information about layout of a network, changes in a network, errors in a network, errors in a transmission, etc. However, the load balancer of the present invention is configured to handle these aforesaid scenarios. The load-balancer can simply drop these messages. The load-balancer can dynamically choose the server to which the packet is to be sent. Alternatively, the load-balancer can just send such packet to a default server. As described in the foregoing description, the load-balancer is configured to thoroughly examine the packet to determine the server to which the packet shall be sent.

Referring to FIG. 4, distributed servers 308a-d can send ICMP messages to client server 302, and the load-balancer will simply forward the packets as it would any other packet. The client server 302 can send ICMP messages to load balancer 304 that do not have any type of port numbers. This message is a basic ICMP message, like a ping. Load-balancer 304 is configured to implement any one of several options. In one option, load balancer 304 can just drop the messages. In another option, load balancer 304 can send the message to a default server, if available. In a further option, the load balancer 304 can be configured to route different ICMP messages to different recipient servers. In yet another option, the load-balancer can load-balance these messages, thus, dynamically choosing the server to which the packet will be forwarded. ICMP messages can be sent from the client or network wherein port numbers can be determined even though ICMP messages do not have a port number field in the header. One example is ICMP error messages. ICMP error messages are produced when a computer/server sends a packet that produces some type of error in the network. This error results in an ICMP error message being sent from the location where the error is detected back to the computer/server that originally sent the packet. If a distributed server (e.g. one of servers 308a-d) send a packet that results in an ICMP error being generated, that distributed server needs to receive the error message. In accordance with the present invention, load balancer 304 examines the message to determine the distributed server that must receive the error message. This function is accomplished in the following manner. Typically, ICMP error messages are configured to that the header and the first 64 bits of the data packet that caused the error are appended to the header of the ICMP error message. This information is included as data in the ICMP packet, but the TCP (or UDP) header that is included in the ICMP message contains the source port number of the packet that caused the error. In accordance with the invention, load balancer 304 examines the ICMP packet's data to retrieve the source port number of the original packet (the packet that was originally sent by a distributed server) to determine the distributed server to which the packet (i.e. error message) is to be sent.

Once the load-balancer determines the port number, the load-balancer can be configured to effect one of several options. In one option, the load-balancer can just drop the packet. In another option, the load-balancer can still send the packet to a default server. In a further option, the load-balancer can dynamically choose a server to send the message. In yet another option, the load-balancer will most likely send the packet to the server that has the port number as a service port number.

The load balancer of the present invention is configured to communicate on several different layers of the OSI networking model 10 including the network and the datalink layers 22 and 24, respectively.

Communication on the Network Layer

The servers of data communication network 400 (e.g. servers 402, 412, 414, 416 and 418 can address each other using the network layer 22 of OSI model 10. In such a configuration, each of the servers has a unique network address. Load balancer 404 is configured to have a table that relates destination port numbers of the packets to the network addresses of the servers. When load balancer 404 receives a packet and determines the server to which the packet is to be sent, load balancer 404 performs the necessary changes to the packet as defined by the appropriate protocols, like substituting the destination network address of the packet with the network address of the destination server and recalculating the necessary checksums, and, then, forwards the packet to the destination server. Communicating on the network layer allows for the servers to be located anywhere on the network, so the recipient servers do not have to be directly connected to the load balancer. In between the load balancer and the recipient servers, there can be numerous standard networking devices, like routers, switches, and hubs. In order for the packet to reach the recipient, the load balancer passes the modified packet onto the network, and the network performs its standard responsibilities to get the packet to the recipient server. The table stored in load balancer 404 can be used to store many information segments. For example, it is probably necessary for the load balancer to also change the datalink address of the packet when forwarding a packet, so it is also necessary to store the destination datalink addresses of the servers.

Communication on the Datalink Layer

The servers of data communication network 400 (e.g. servers 402, 412, 414, 416 and 418 can address each other using the datalink layer 24 of OSI model 10. In such a configuration, each of the servers has a unique datalink or Ethernet address. In such a configuration, all of the servers in data communication network 400 have the same network address so the load balancer 404 does not have to change anything in the network level. In this configuration, load balancer 404 is configured to have a pre-stored table that associates destination port numbers with datalink addresses of the servers. When a packet arrives, load balancer 404 determines the server that receives the data packet. Next, load balancer 404 replaces the destination datalink address in the packet with the destination datalink address of the determined destination server, and then forwards the packet to that determined destination server. One advantage of this configuration is that it is not necessary to access the network level 22. Thus, the network level checksum does not have to be recalculated. Communicating on the datalink layer allows for the servers to be located any where on the same subnet of the network, so the recipient servers do not have to be directly connected to the load balancer. In between the load balancer and the recipient servers there can be numerous standard networking devices, like switches and hubs. In order for the packet to reach the recipient, the load balancer passes the modified packet onto the network, and the network performs its standard responsibilities to get the packet to the recipient server.

Although data communication network 400 is in the form of a tree, it is not necessary to use a tree configuration in order effect data transmission on either the network level 22 or datalink level 24 as described in the foregoing description. When communicating on the network level or the datalink level, the tree is just a conceptual description of the system. The load balancer can actually have a single external connector through which it communicates to the appropriate devices including the client and the recipient servers.

### Optimized Communication

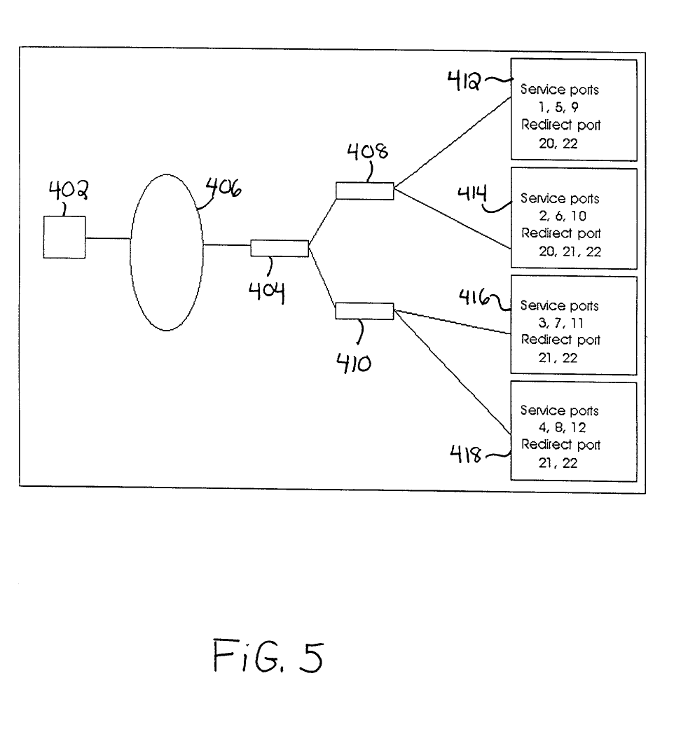

Referring to FIG. 5, there is shown data communication network 400 which comprises client server 402 and load balancer 404 that are in data communication with network 406. Data communication network 400 further comprises load balancers 408 and 410 that are in data communication with load balancer 404. Load balancer 408 is in data communication with recipient servers 412 and 414 and load balancer 410 is in data communication with recipient servers 416 and 418. Data communication network 400 is in the configuration of a “tree”. Typically, the flow of data is only up and down the tree. In other words, load-balancer 404 receives data and sends that data down to load-balancer 408, and load-balancer 408 sends the data to recipient server 412. Recipient server 412 then sends data to load-balancer 408 which then sends the data to load-balancer 404. When packets are being passed up and down the tree, the load balancers may or may not examine the packets, but there is no need for them to change the packets. The load balancers can pass the packets without changing any fields within the packet. Thus, in the normal course of passing packets from the client server to the recipient servers or passing packets from the recipient servers to the client server, none of the devices in the load balancing system really communicate with each other. They can just examine and pass the packets.

A further embodiment of the invention is to effect data communication between the client server and recipient servers of a data communication network without the need for any of the servers to specifically address each other. In such a configuration, all of the servers have the same network destination address and datalink destination address, and each server is directly connected to the load balancer. The load balancer maintains a pre-stored table that relates port numbers with servers. When a packet arrives, the load balancer examines the destination port number of the packet so as to determine which server shall receive the packet. Next, the load balancer forwards the packet to the appropriate server without changing any fields within the packet. Since the web server does not have to change any of the fields within the packet, no checksums have to be recalculated. Such a configuration is appropriate when the servers are just sending packets up and down the tree. However, the foregoing configuration also can be used in a data communication network wherein each server must communicate with other servers. In such a data communication network, each server has the same network destination address and datalink destination address for sending packets up and down the tree, and an additional but different address that is used in effecting communication with other servers.

The principals, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

Thus, having described the invention, what is claimed is:

1. A method of operating a data communication network having at least one client server and a plurality of recipient servers wherein the client servers and recipient servers exchange data packets, each of the recipient servers having at least one unique service port number and at least one redirect port number wherein more than one recipient server shares the same redirect port number, the method comprising the steps of:
providing a data packet configured to include a first data segment indicating a destination port number;
providing a load balancer configured for effecting transfer of data packets between the client server and recipient servers, the load balancer being configured to examine the first data segment in the data packets to determine which of the recipient servers shall receive the data packet;
determining the destination port number in each first data segment;
determining whether the destination port number in each first data segment matches a service port number of one of the recipient servers or a redirect port number for a subset of the plurality of recipient servers;
forwarding the data packet to the recipient server that has a service port number that matches the destination port number in the data packet if the destination port number is determined to be a service port number for that particular recipient server;
selecting a recipient server from a subset of recipient servers that has a redirect port number that matches the destination port number if the destination port number is determined to be a service port number for the subset of recipient servers;
forwarding the data packet to the selected recipient server;
configuring a data packet as a reply to the data packet received by the selected server from the client server to include a second data segment that indicates a service port number to which the client server shall direct all subsequent data packets;
thereafter forwarding the configured data packet back to the client server;
reconfiguring the configured data packet received by the client server to indicate a destination port number that matches the service port number defined in the second data segment; and
forwarding the reconfigured data packet to a recipient server that services the service port number defined in the fourth data segment.

2. The method according to claim 1 further comprising the steps of:
designating one of the recipient servers as a default server if it is determined that the first data segment defines a destination port number that does not match any of the service port numbers and redirect port numbers of the recipient servers; and
forwarding the data packet to the recipient server that is designated as the default server if the first data segment defines a destination port number that does not match any of the service port numbers and redirect port numbers of the recipient servers.

3. A method of operating a data communication network having at least one client server and a plurality of recipient servers wherein the client servers and recipient servers exchange data packets, each of the recipient servers having at least one unique service port number and at least one redirect port number wherein more than one recipient server shares the same redirect port number, the method comprising the steps of:
providing a data packet configured to include a first data segment indicating a destination port number, a second data segment indicating whether the client server is configured to provide port redirection, and a third data segment that enables the recipient servers to acknowledge that the client server is configured to provide port redirection and to indicate to the client server that the recipient server supports port redirection;
providing a load balancer configured for effecting transfer of data packets between the client server and recipient servers, the load balancer being configured to examine the data segments in the data packets to determine which of the recipient servers shall receive the data packet;
determining the destination port number in each first data segment;
determining whether the destination port number in each first data segment matches a service port number of one of the recipient servers or a redirect port number for a subset of recipient servers;
forwarding the data packet to the recipient server that has a service port number that matches the destination port number in the data packet if the destination port number is determined to be a service port number for that particular recipient server;
selecting a recipient server from a subset of the plurality of recipient servers that has a redirect port number that matches the destination port number if the destination port number is determined to be a service port number for the subset of recipient servers and if the second data segment indicates that the client server supports port redirection;
forwarding the data packet to the selected server if the second data segment indicates that the client server supports port redirection;
configuring a data packet as a reply to the data packet received by the selected server from the client to indicate that the recipient server acknowledges that the client server supports port redirection and that the recipient server supports port redirection, and to include a forth data segment that indicates a service port number to which the client server shall direct all subsequent data packets;
thereafter forwarding the configured data packet back to the client server;
reconfiguring the configured data packet received by the client server to indicate a destination port number that matches the service port number defined in the fourth data segment; and
forwarding the reconfigured data packet to a recipient server that services the service port number defined in the fourth data segment.

4. The method according to claim 3 wherein the second data segment comprises a flag that, when set, indicates that the client server supports port redirection, and when not set, indicates the client server does not support port redirection.

5. The method according to claim 4 wherein the third data segment comprises a flag that, when set, indicates the recipient server acknowledges that the client server supports port redirection and the recipient server supports port redirection, and when not set, indicates the recipient server acknowledges that the client server does not support port redirection and/or the recipient server does not support port redirection.

6. The method according to claim 3 the method further includes the steps of:
designating one of the recipient servers as a default server if it is determined that the second data segment indicates that the client server does not support port redirection; and
forwarding the data packet to the recipient server that is designated as the default server if the first data segment defines a destination port number that does not match any of the service port numbers and redirect port numbers of the recipient servers.

7. The method according to claim 3 wherein the load balancer is programmable and the step of providing the load balancer further includes the step of programming the load balancer with (i) the service and redirect port numbers of the plurality of recipient servers, and (ii) destination port numbers that correspond to the service port numbers.

8. The method according to claim 7 wherein the load balancer includes a plurality of external connectors wherein each external connector is connected to a corresponding recipient server, the method further comprising the step of assigning destination port numbers to the external connectors.

9. A data communication network comprising:
at least one client server;
a plurality of recipient servers, each of said recipient servers having at least one unique service port number and at least one redirect port number wherein a subset of the recipient servers shares the same redirect port number;
means for providing a data packet configured to include a first data segment indicating a destination port number;
a load balancer in data communication with said client server and said recipient servers, said load balancer being configured to examine the first data segments in the data packet to determine which of said recipient servers shall receive the data packet;
said load balancer being configured to determine the destination port number in each first data segment;
said load balancer being configured to determine whether the destination port number in each first data segment matches a service port number of one of said recipient servers or a redirect port number for a subset of said recipient servers;
said load balancer being configured to forward the data packet to said recipient server that has a service port number that matches the destination port number in the data packet if the destination port number is determined to be a service port number for said server;
said load balancer being configured to select a recipient server from a subset of said recipient servers that have a redirect port number that matches the destination port number if the destination port number is determined to be a service port number for said set of said recipient servers;
said load balancer being configured to forward the data packet to the selected server;
means for configuring a data packet as a reply to the data packet received by said selected server from the client to include a forth data segment that indicates a service port number to which said client server shall direct all subsequent data packets;
means for forwarding the configured data packet to said load balancer;
said load balancer being configured to forward the configured data packet back to said client server;
means for reconfiguring the configured data packet received by said client server to indicate a destination port number that matches the service port number defined in the second data segment;
means for forwarding the reconfigured data packet to said load balancer; and
said load balancer being configured to forward the reconfigured data packet to a recipient server that services the service port number defined in the second data segment.

10. A data communication network comprising:
at least one client server;
a plurality of recipient servers, each of said recipient servers having at least one unique service port number and at least one redirect port number wherein more than one recipient server shares the same redirect port number;
means for providing a data packet configured to include a first data segment indicating a destination port number, a second data segment indicating whether the client server is configured to provide port redirection, and a third data segment that enables the recipient servers to acknowledge that the client server is configured to provide port redirection and to indicate to the client that the recipient server supports port redirection;
a load balancer in data communication with said client server and said recipient servers, said load balancer being configured to examine the data segments in the data packet to determine which of said recipient servers shall receive the data packet;
said load balancer being configured to determine the destination port number in each first data segment;
said load balancer being configured to determine whether the destination port number in each first data segment matches a service port number of one of said recipient servers or a redirect port number for a subset of said recipient servers;
said load balancer being configured to forward the data packet to a particular recipient server that has a service port number that matches the destination port number in the data packet if the destination port number is determined to be a service port number for that particular server;
said load balancer being configured to select a recipient server from a set of said recipient servers that has a redirect port number that matches the destination port number if the destination port number is determined to be a service port number for said set of recipient servers and if the second data segment indicates that said client server supports port redirection;
said load balancer being configured to forward the data packet to the selected server if the second data segment indicates that said client server supports port redirection;
means for configuring a data packet as a reply to the data packet received by said selected server from the client to indicate that the recipient server acknowledges that said client server supports port redirection and that the recipient server supports port redirection, and to include a forth data segment that indicates a service port number to which said client server shall direct all subsequent data packets;
means for forwarding the configured data packet to said load balancer;
said load balancer being configured to forward the configured data packet back to said client server;
means for reconfiguring the configured data packet received by said client server to indicate a destination port number that matches the service port number defined in the forth data segment;
means for forwarding the reconfigured data packet to said load balancer; and
said load balancer being configured to forward the reconfigured data packet to a recipient server that services the service port number defined in the fourth data segment.

11. The data communication network according to claim 10 wherein the second data segment comprises a flag that, when set, indicates that the client server supports port redirection and when not set, indicates that the client server does not support port redirection.

12. The data communication network to claim 11 wherein the third data segment comprises a flag, when set, indicates the recipient server acknowledges that the client server supports port redirection and the recipient server supports port redirection and when not set, indicates the recipient server acknowledges that the client server does not support port redirection and/or the recipient server does not support port redirection.

13. The data communication network according to claim 10 wherein the load balancer further comprises:
means for designating one of the recipient servers as a default server if the determining means determines that the second data segment indicates that the client server does not support port redirection; and
means for forwarding the data packet to the recipient server that is designated as the default server if the first data segment defines a destination port number that does not match any of the service port numbers and redirect port numbers of the recipient servers.

14. The data communication network according to claim 13 wherein the load balancer is programmable and the load balancer further comprises means for programming the load balancer with the service and redirect port numbers of the recipient servers, and destination port numbers that correspond to the service port numbers.

15. A load balancer for effecting data communication between at least one client server and a plurality least two recipient servers wherein each of the recipient servers having at least one unique service port number and at least one redirect port number wherein more than one recipient server shares the same redirect port number, the load balancer comprising:
means for receiving data packets configured to include a first data segment indicating a destination port number;
means for examining the first data segments in the data packet to the destination port number in each first data segment;
means for determining whether the destination port number in each first data segment matches a service port number of one of said recipient servers or a redirect port number for a subset of said recipient servers;
means for forwarding the data packet to a particular recipient server that has a service port number that matches the destination port number in the data packet if the destination port number is determined to be a service port number for that particular server;
means for selecting a recipient server from a subset of the plurality of recipient servers that has a redirect port number that matches the destination port number if the destination port number is determined to be a service port number for said set of recipient servers;
means for forwarding the data packet to the selected server;
means for processing data packets responsively sent by the selected server to determine if the data packets sent by the selected server includes a second data segment that indicates a service port number to which the client server shall direct all subsequent data packets;
means for forwarding the processed data packets to the client server;
means for processing data packets responsively sent by the client server to determine if the data packet includes a destination port number that matches the service port number defined in the second data segment; and
means for forwarding the data packet received from the client server to a recipient server that services the service port number defined in the second data segment.

16. The data communication network according to claim 15 wherein the load balancer further comprises:
means for designating one of the recipient servers as a default server if the determining means determines that the first data segment defines a destination port number that does not match any of the service port numbers and redirect port numbers of the recipient servers; and
means for forwarding the data packet to the recipient server that is designated as the default server.

17. A load balancer for effecting data communication between at least one client server and at least two recipient servers wherein each of the recipient servers having at least one unique service port number and at least one redirect port number wherein more than one recipient server shares the same redirect port number, the load balancer comprising:
means for receiving data packets configured to include a first data segment indicating a destination port number, a second data segment indicating whether the client server is configured to provide port redirection, and a third data segment that enables the recipient servers to acknowledge that the client server is configured to provide port redirection;
means for examining the data segments in the data packet to the destination port number in each first data segment;
means for determining whether the destination port number in each first data segment matches a service port number of one of said recipient servers or a redirect port number for a subset of said recipient servers;
means for forwarding the data packet to a recipient server that has a service port number that matches the destination port number in the data packet if the destination port number is determined to be a service port number for said server;
means for selecting a recipient server from a subset of said recipient servers that has a redirect port number that matches the destination port number if the destination port number is determined to be a service port number for said subset of recipient servers and if the second data segment indicates that said client server supports port redirection;
means for forwarding the data packet to the selected server if the second data segment indicates that said client server supports port redirection;
means for processing data packets responsively sent by the selected server to determine if the recipient server acknowledges that the client server supports port redirection and that the recipient server supports port redirection, and to determine if the data packets sent by the selected server includes a forth data segment that indicates a service port number to which the client server shall direct all subsequent data packets;
means for forwarding the processed data packets to the client server;
means for processing data packets responsively sent by the client server to determine if the data packet includes a destination port number that matches the service port number defined in the forth data segment; and
means for forwarding the data packet received from the client server to a recipient server that services the service port number defined in the fourth data segment.

18. The load balancer according to claim 17 wherein the load balancer further comprises:
means for designating one of the recipient servers as a default server if the determining means determines that the second data segment indicates that the client server does not support port redirection; and
means for forwarding the data packet to the recipient server that is designated as the default server if the first data segment defines a destination port number that does not match any of the service port numbers and redirect port numbers of the recipient servers.

19. The load balancer according to claim 18 wherein the load balancer is configured to be programmable and the load balancer further comprises means for programming the load balancer with the service and redirect port numbers of the recipient servers.

20. A load balancing method for effecting data communication between at least one client server and a plurality of recipient servers wherein each of the recipient servers having at least one unique service port number and at least one redirect port number wherein more than one recipient server shares the same re direct port number, the load balancing method comprising:
receiving data packets configured to include a first data segment indicating a destination port number;
examining the data segments in the data packet to the destination port number in each first data segment;
determining whether the destination port number in each first data segment matches a service port number of one of said recipient servers or a redirect port number for a subset of said recipient servers;
forwarding the data packet to a recipient server that has a service port number that matches the destination port number in the data packet if the destination port number is determined to be a service port number for that particular recipient server;
selecting a recipient server from a subset of the plurality of recipient servers that has a redirect port number that matches the destination port number if the destination port number is determined to be a service port number for said subset of recipient servers;
forwarding the data packet to the selected recipient server;
processing data packets responsively sent by the selected server to determine if the data packets sent by the selected server includes a second data segment that indicates a service port number to which the client server shall direct all subsequent data packets;
forwarding the processed data packets to the client server;
processing data packets responsively sent by the client server to determine if the data packet includes a destination port number that matches the service port number defined in the forth data segment; and
forwarding the data packet received from the client server to a recipient server that services the service port number defined in the second data segment.

21. The load balancing method according to claim 20 further comprises:
designating one of the recipient servers as a default server if the determining means determines that the first data segment defines a destination port number that does not match any of the service port numbers and redirect port numbers of the recipient servers; and
forwarding the data packet to the recipient server that is designated as the default server if the first data segment defines a destination port number that does not match any of the service port numbers and redirect port numbers of the recipient servers.

22. A data packet configured for use in a data communication network having at least one client server and a plurality of recipient servers, the data packet comprising a data segment indicating a destination port number.

23. The data packet according to claim 22 further comprising a second data segment that indicates a service port number to which the client server shall redirect subsequent data packets.

24. A load balancing method for effecting data communication between at least one client server and at least two recipient servers wherein each of the recipient servers has at least one unique service port number and at least one redirect port number wherein more than one recipient server shares the same redirect port number, the load balancing method comprising the steps of:
receiving data packets configured to include a first data segment indicating a destination port number, a second data segment indicating whether the client server is configured to provide port redirection, and a third data segment that enables the recipient servers to acknowledge that the client server is configured to provide port redirection;
examining the data segments in the data packet to the destination port number in each first data segment;
determining whether the destination port number in each first data segment matches a service port number of one of said recipient servers or a redirect port number for a subset of said recipient servers;
forwarding the data packet to said recipient server that has a service port number that matches the destination port number in the data packet if the destination port number is determined to be a service port number for said server;
selecting a recipient server from a subset of said recipient servers that has a redirect port number that matches the destination port number if the destination port number is determined to be a service port number for said set of recipient servers and if the second data segment indicates that said client server supports port redirection;
forwarding the data packet to the selected server if the second data segment indicates that said client server supports port redirection;
processing data packets responsively sent by the selected server to determine if the recipient server acknowledges that the client server supports port redirection and that the recipient server supports port redirection, and to determine if the data packets sent by the selected server includes a forth data segment that indicates a service port number to which the client server shall direct all subsequent data packets;
forwarding the processed data packets to the client server;
processing data packets responsively sent by the client server to determine if the data packet includes a destination port number that matches the service port number defined in the forth data segment; and
forwarding the data packet received from the client server to a recipient server that services the service port number defined in the fourth data segment.

25. The load balancing method according to claim 24 further comprises:
designating one of the recipient servers as a default server if the determining means determines that the second data segment indicates that the client server does not support port redirection; and
forwarding the data packet to the recipient server that is designated as the default server if the first data segment defines a destination port number that does not match any of the service port numbers and redirect port numbers of the recipient servers.

26. A data packet configured for use in a data communication network having at least one client server and a plurality of recipient servers, the data packet comprising:
a first data segment indicating a destination port number;
a second data segment indicating whether the client server is configured to provide port redirection; and
a third data segment that enables the recipient servers to acknowledge that the client server is configured to provide port redirection.

27. The data packet according to claim 24 further comprising a fourth data segment that indicates a service port number to which the client server shall redirect subsequent data packets.
